(19) United States
(12) Patent Application Publication
(10) Pub. No.: US 2013/0128729 A1
(43) Pub. Date: May 23, 2013

(54) COMMUNICATION NETWORK OPERATOR TRAFFIC REGULATION MANAGER AND DATA COLLECTION MANAGER AND METHOD OF OPERATION THEREOF

(71) Applicants: Vinod T. Nair, Austin, TX (US); Arabinda Bosa, Cedar Park, TX (US); Abhijeet J. Auradkar, Bangalore (IN); Padmakumar Subramani, Chenai (IN)

(72) Inventors: Vinod T. Nair, Austin, TX (US); Arabinda Bosa, Cedar Park, TX (US); Abhijeet J. Auradkar, Bangalore (IN); Padmakumar Subramani, Chenai (IN)

(73) Assignees: Alcatel-Lucent India, Limited, Bangalore (IN); Alcatel-Lucent USA, Incorporated, Murray Hill, NJ (US)

(21) Appl. No.: 13/616,920

(22) Filed: Sep. 14, 2012

Related U.S. Application Data
(60) Provisional application No. 61/562,668, filed on Nov. 22, 2011.

(51) Int. Cl. H04L 12/24; H04L 12/26; H04L 12/56

(52) U.S. Cl. 370/229

(57) ABSTRACT

A traffic regulation manager, a method of regulating basic management and supplemental traffic and a communication network operator architecture. In one embodiment, the traffic regulation manager includes: (1) a payload analyzer configured to receive management and supplemental information from customer premises equipment devices, examine payloads of packets bearing the management and supplemental information to identify the management session and, if a packet is bearing the supplemental information, forward the packet to a data collection manager, (2) a traffic prioritizer coupled to the payload analyzer and configured to receive the packets bearing the management information from the payload analyzer and prioritize the packets according to at least one criterion and (3) a traffic allocator coupled to the traffic prioritizer and configured to distribute management traffic representing new management sessions among management servers and packets representing existing management sessions to a management server already handling the existing management sessions.

### CROSS-REFERENCE TO RELATED APPLICATION

This application claims the benefit of U.S. Provisional Application Ser. No. 61/562,668, filed by Nair, et al., on Nov. 22, 2011, entitled “Data Collection Manager and Traffic Regulation Manager for Data Collection System,” commonly assigned with this application and incorporated herein by reference.

### TECHNICAL FIELD

This application is directed, in general, to a network management and, more specifically, to network traffic prioritization, routing and management.

### BACKGROUND

Customer premise equipment (CPE) devices (also called “user equipment,” or UE), such as including routers, gateways, set-top boxes and femtocells, provide access to communications services such as telephone and data transmission, Internet access and television. Access networks provide a way for the CPE devices, which may be mobile or fixed in a home or business, to reach a communications network through which all of these services may be made available.

Given the immense numbers of CPE devices that need to be managed, it has become common for access network providers to employ software called “communications network operators” (CNOs) to manage the CPE devices. CNOs provide management services, e.g., provisioning, configuration, maintenance, troubleshooting, fault management, software updating and service upgrading without the need for involvement, or at least extensive involvement, by either the service provider or the customer. CPE devices typically exchange status-related messages and responses with a CNO, allowing the CNO to be informed of the operational status of each managed device. CNOs such as, for example, the Home Device Manager (HDM) and Mobile Device Manager (MDM) commercially available from Motive, Inc., of Austin, Tex., communicate with home and mobile devices according to standard or proprietary protocols to perform management services in this way.

Standard and proprietary management protocols have been developed to allow CNOs to communicate with CPE devices to perform management services. One such standard protocol is the TR-069 CPE wide-area network (WAN) management protocol (CWMP), promulgated by the Technical Report 069 Broadband Forum. TR-069 is widely used today to manage many different kinds of CPE devices. Another such standard protocol is the Open Mobile Alliance (OMA) device management (OMADM) protocol, directed primarily to performing management services with respect to mobile devices.

### SUMMARY

One aspect provides a traffic regulation manager (TRM). In one embodiment, the TRM includes: (1) a payload analyzer configured to receive management and supplemental information from CPE devices, examine payloads of packets bearing the management and supplemental information to identify the management session and, if a packet is bearing the supplemental information, forward the packet to a data collection manager (DCM), (2) a traffic prioritizer coupled to the payload analyzer and configured to receive the packets bearing the management information from the payload analyzer and prioritize the packets according to at least one criterion and (3) a traffic allocator coupled to the traffic prioritizer and configured to distribute management traffic representing new management sessions among management servers and packets representing existing management sessions to a management server already handling the existing management sessions.

Another aspect provides a method of regulating basic management and supplemental traffic. In one embodiment, the method includes: (1) receiving management and supplemental traffic from a network, (2) analyzing a packet payload to determine a type of traffic the packet represents, (3) if the packet represents supplemental traffic, forwarding the packet to a DCM, (4) if a packet represents management traffic, assigning a priority to the packet and (5) allocating the management traffic among management servers.

Yet another aspect provides a communication network operator architecture. In one embodiment, the architecture includes: (1) a plurality of management servers, (2) a DCM and (3) a TRM coupled to the plurality of management servers and the DCM. The TRM includes: (3a) a payload analyzer configured to receive management and supplemental information from CPE devices, examine payloads of packets bearing the management and supplemental information to identify the management session and, if a packet is bearing the supplemental information, forward the packet to a DCM, (3b) a traffic prioritizer coupled to the payload analyzer and configured to receive the packets bearing the management information from the payload analyzer and prioritize the packets according to at least one criterion and (3c) a traffic allocator coupled to the traffic prioritizer and configured to distribute management traffic representing new management sessions among the plurality of management servers and packets representing existing management sessions to a management server already handling the existing management sessions, the DCM configured to collect, store and report at least the supplemental information.

### BRIEF DESCRIPTION

Reference is now made to the following descriptions taken in conjunction with the accompanying drawings, in which:

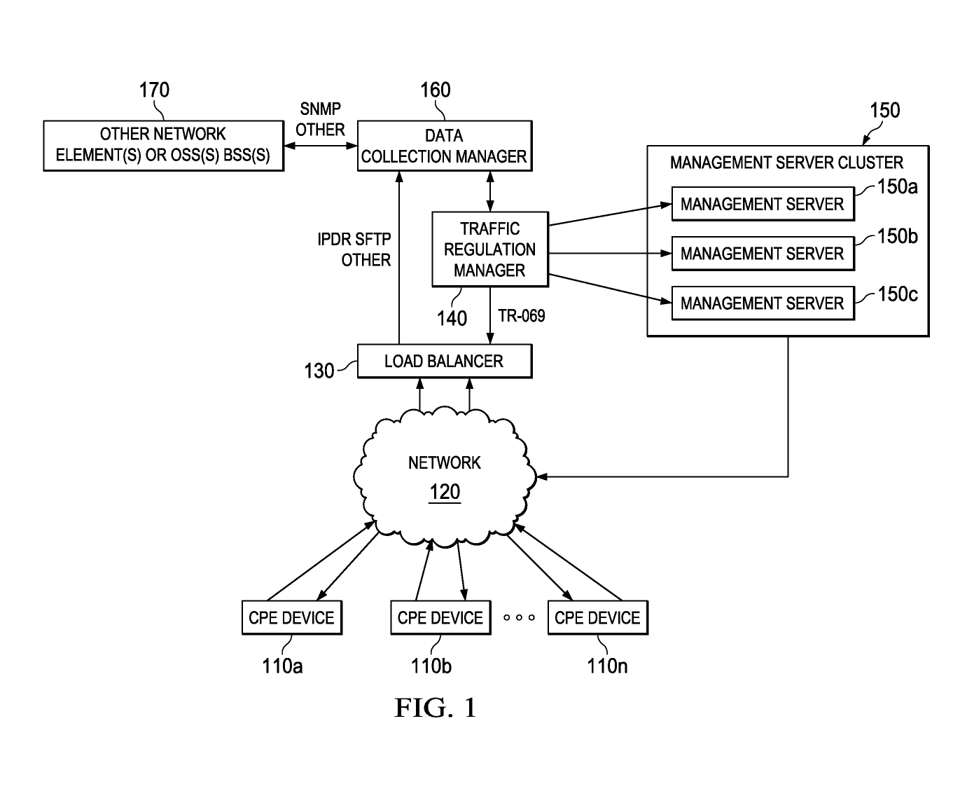

FIG. 1 is a block diagram illustrating one embodiment of a CNO architecture in which a TRM and a DCM cooperate with one or more management servers;

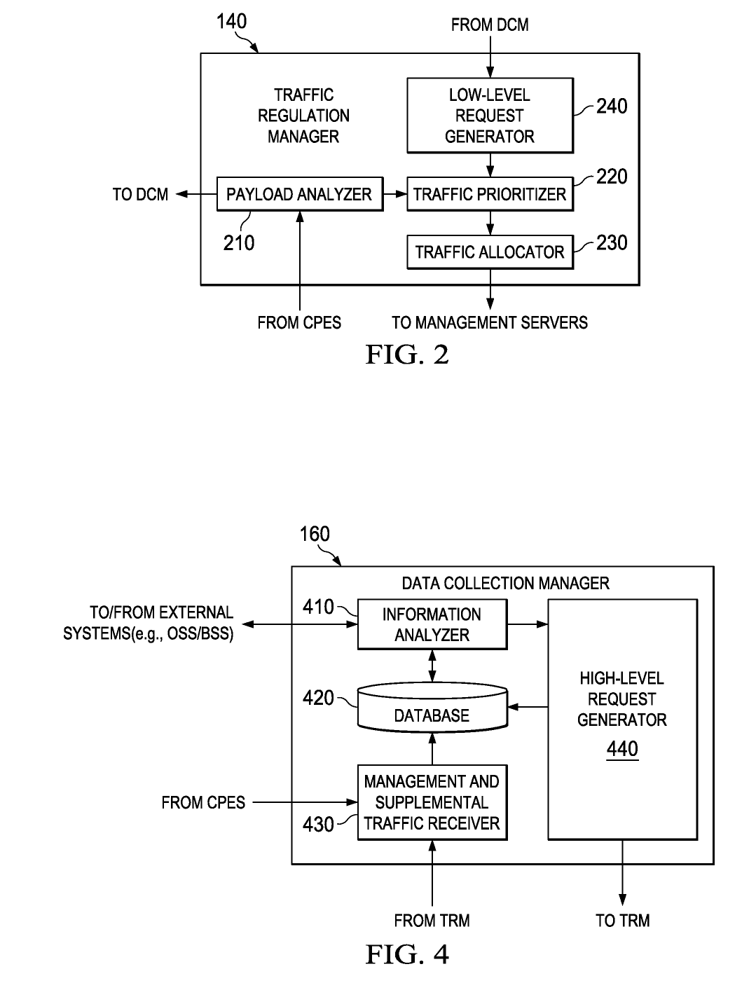

FIG. 2 is a block diagram of one embodiment of the TRM of FIG. 1;

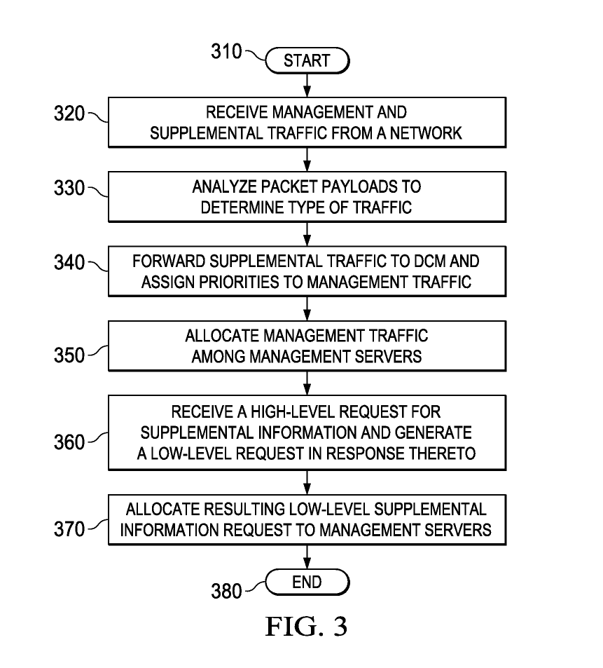

FIG. 3 is a flow diagram of one embodiment of a method of regulating management and supplemental traffic;

FIG. 4 is a block diagram of one embodiment of the DCM of FIG. 1; and

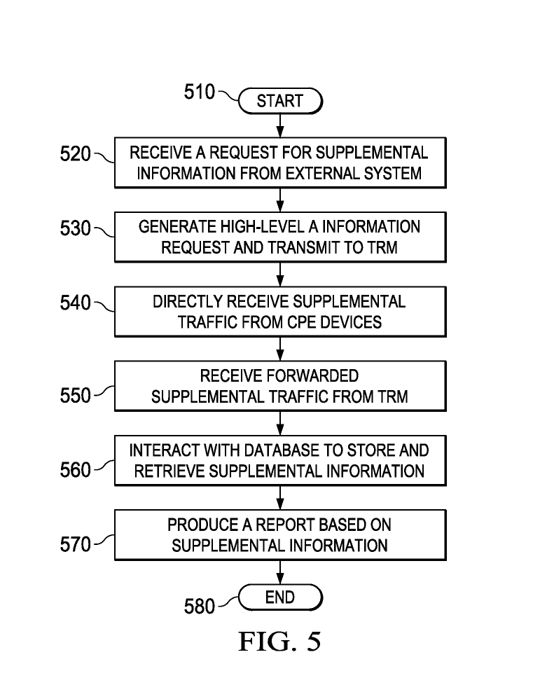

FIG. 5 is a flow diagram of one embodiment of a method of requesting and collecting supplemental data.

### DETAILED DESCRIPTION

As stated above, CNOs provide management services to CPE devices without the need for involvement, or at least extensive involvement, by either the service provider or the customer. CNOs should handle not only high management traffic volumes normally generated by large numbers of the CPE devices under management, but also surges in management traffic volumes when CPE devices attempt to reconnect to the CNO en masse after an unforeseen event such as a network or power outage. Accordingly, various management traffic regulation schemes have been developed by which the flow of management traffic is regulated, and the traffic mix reaching the CNO is adjusted. Some of the schemes involve altering the traffic mix reaching the management servers to favor high-priority events (such as critical notifications, or device responses to operator-initiated actions). U.S. patent application Ser. No. 12/972,714, filed by Nair, et al., on Dec. 20, 2010, entitled “Method and Apparatus for Traffic Regulation in a communication Network” and incorporated herein by reference, is directed to a particularly advantageous management traffic regulation scheme and will be referred to as “Nair.” Overall, management traffic regulation schemes in general, and particularly that of Nair, have improved management traffic flow.

Some of the above-described proprietary and standard protocols provide a mechanism by which substantially more information can be made available than the management information required to perform management services. For example, TR-069 and OMADM devices have rich object models from which a variety of data about the managed device and its network environment may be extracted.

Managed devices can also be configured to report valuable information on an occasional, e.g., periodic basis. It is realized herein that this supplemental information has the potential to be used for purposes other than providing management services. As an aside, “supplemental information” is defined as information not required to perform management services. “Management information” is accordingly defined as information required to perform management services. In like manner, “supplemental traffic” is defined as traffic resulting from the communication of supplemental information, and “management traffic” is defined as traffic resulting from the communication of management information. Both supplemental traffic and management traffic typically take the form of packets bearing messages, parameter values and other routing and control information and data, transmitted to and from CPE devices.

For example, it is realized herein that device and network monitoring and optimization, proactive troubleshooting, the offering of additional value-added services and even targeted or mass marketing, can become possible and sophisticated given this supplemental information. It is therefore realized herein that collecting supplemental information is desirable from both a network optimization and an economic perspective.

Unfortunately, it is also realized herein that the amount of supplemental traffic may get very large and that current protocols and traffic regulation schemes are not well-suited to handling the supplemental traffic. Scenarios may be envisioned where current systems would be overwhelmed.

Compounding this problem is that the current generation of TR-069 devices do not yet support a standard data collection mechanism based on the TR-232 bulk data collection standard proposed by the Broadband forum, which would allow the TR-069 device itself to direct transmission of supplemental data to a separate server (that is, one that is different from a management server) using the Internet Protocol Detail Record (IPDR), the Secure File Transfer Protocol (SFTP) or other protocols. It is therefore realized herein that a CNO would benefit from a mechanism that automatically extracts the supplemental information from the traffic sent to the CNO to avoid overwhelming it with a high traffic volume.

It is also realized herein that a novel traffic management scheme that accommodates and correctly manages a full flow of traffic including not only management traffic, but the supplemental traffic described above, would be advantageous. Particularly advantageous would be a novel traffic management scheme that is able to function in the absence of support for the TR-232 standard within the TR-069 device. What is further needed is an improved TRM that incorporates the novel traffic management scheme. What is still further needed is a comprehensive information collection scheme capable of effectively collecting, storing and reporting in various ways the management and supplemental information. What is yet further needed is an information collection scheme that is highly scalable given the huge volumes of data that often need to be handled.

Accordingly, introduced herein are various embodiments of a TRM and DCM that cooperate with one or more management servers to manage the management and supplemental information described above. Also introduced herein are various embodiments of methods of requesting management and supplemental information and collecting the management and supplemental traffic provided either in response to a request or without having been requested. Certain of the TRM and method embodiments operate in the absence of advanced routing protocols.

FIG. 1 is a block diagram illustrating one embodiment of a CNO architecture in which a TRM and a DCM cooperate with one or more management servers. Shown are a plurality of CPE devices 110a, 110b, . . . , 110n. In some embodiments, the plurality of CPE devices 110a, 110b, . . . , 110n may number in the tens or hundreds of thousands, or even in the millions or tens of millions. In the illustrated embodiment, the CPE devices 110a, 110b, . . . , 110n represent a variety of manufacturers and models having a variety of capabilities. However, all of the CPE devices 110a, 110b, . . . , 110n support a current proprietary or standard remote management protocol such as TR-069 or OMADM. In other embodiments, at least some of the CPE devices 110a, 110b, . . . 110n support later-developed proprietary or standard remote management protocols. Some of the CPE devices 110a, 110b, . . . , 110n support IPDR or SFTP.

The CPE devices 110a, 110b, . . . , 110n are coupled to a network 120. In the illustrated embodiment, the network 120 is the Internet. In alternative embodiments, the network 120 is another suitable computer or data network.

A load balancer 130 is coupled to the network 120. In the illustrated embodiment, the load balancer 130 is a conventional load balancer and thus capable of distributing traffic across multiple computers or a computer cluster to improve resource utilization, increase throughput and decrease response time and overloads. In the context of FIG. 1, the load balancer 130 is configured to distribute traffic among multiple TRMs, multiple DCMs or both multiple TRMs and multiple DCMs.

A TRM 140 is coupled to the load balancer 130. Multiple TRMs may be present in a given CNO; however, FIG. 1 shows only the TRM 140 for simplicity's sake. In the illustrated embodiment, the TRM 140 is configured to distribute traffic across multiple management servers or a management server cluster to improve resource utilization, increase throughput and decrease response time and overloads.

In the context of FIG. 1, the TRM 140 is configured to distribute basic management traffic in accordance with the traffic regulation scheme for management information disclosed in Nair. Nair discloses various embodiments of a TRM 140 having several significant features in various combinations:

(1) a configurable set of rules governing traffic prioritization;

(2) rules specified in terms of cut-off percentages of a total backend server capacity allocated to a given type of TR-069 event type, together with disambiguation rules to cover cases when multiple TR-069 event types are in session initiation messages;

(3) a traffic regulation scheme that takes current load factor into account;

(4) a traffic regulation scheme that maintains continuity of already established (in-progress) sessions for transactional integrity; and

(5) a traffic regulation scheme that either “tunnels” or “deflects” session-initiation messages based on the above criteria.

According to Nair, it is possible to configure the type of response to be sent by the TRM 140 to the CPE device when a session-initiation request from a CPE device is “deflected” due to low priority. The response can either indicate to the CPE device that it must retry (perhaps with an indication of the time delay before attempting the next retry), or the response can indicate that there are no scheduled management tasks at this time for the CPE device.

Because of the ability to specify different weights (importance) to the different types of events, the traffic management scheme is capable of automatically adjusting the traffic mix to favor higher priority events, as the load increases. The speed of this adaptive response from the system is critical in effectively countering dramatic load increase (i.e., a “spike”).

Various embodiments of the traffic management scheme support a maintenance mode of operation, which allows one or more management servers to be safely shut down for maintenance. During downtime, the traffic regulation scheme is capable of interceding for the one or more management servers with an appropriate response to the CPE devices with which they had been interacting, preventing them from aggressively trying to reestablish communication with a management server that is temporarily shut down.

In one embodiment, the TRM 140 is configured to offload certain HTTP-layer functions (such as authentication challenge processing) from management servers to further reduce their loading. In another embodiment, the TRM 140 is configured to will allow session-initiation requests that are “deflected” by the TRM 140 to be logged. In yet another embodiment, the TRM 140 provides a graphical user interface (GUI) to monitor traffic statistics such as session tunnel/deflection rates based on event type, as well as key performance metrics, such as request failure rates and average latency of response seen by the CPE devices from the backend management servers.

The TRM 140 of FIG. 1 is further configured to route supplemental traffic to a DCM, perhaps through a load balancer (not shown). Accordingly, the TRM 140 is further capable of identifying supplemental traffic and forward it to a DCM instead of a management server, such that no management server is burdened with having to accommodate it. In one embodiment, the TRM 140 is still further configured to forward at least some management traffic to a DCM such that the DCM can collect, store and report in various ways both management and supplemental information. Various embodiments of the TRM 140 and functions performable thereby will be illustrated and described more particularly in conjunction with FIGS. 2 and 3, below.

A management server cluster 150 including management servers 150a, 150b, 150c, is coupled to the TRM 140. The management servers 150a, 150b, 150c are configured to provide management services to the CPE devices 110a, 110b, . . . , 110n. In various embodiments, the management servers 150a, 150b, 150c are commercially available management servers of various manufacture. In alternative embodiments, the management servers 150a, 150b, 150c are later-developed management servers capable or providing an enhanced suite of management services to the CPE devices 110a, 110b, . . . , 110n, perhaps employing later-developed, more powerful, management protocols.

A DCM 160 is coupled to the TRM 140. In the illustrated embodiment, the DCM 160 is further coupled to the load balancer 130. Multiple DCMs may be included in various embodiments. However, FIG. 1 includes only the one DCM 160. In the illustrated embodiment, the DCM 160 is configured to collect, store and report in various ways at least supplemental information. Various embodiments of the DCM 160 and functions performable thereby will be illustrated and described more particularly in conjunction with FIGS. 4 and 5, below.

One or more other network elements or one or more operations support systems or business support systems (OSSs/BSSs) 170 are coupled to the DCM 160. The one or more other network elements 170 may include computers such as servers or clients, routers, gateways, links, storage units or printers or commercially available or proprietary OSSs or BSSs configured to make some use of the basic management or supplemental information that the DCM 160 is capable of gathering, storing or reporting. In various embodiments, the OSSs/BSSs are either sources or sinks to the DCM 160. For example, in one embodiment, data that is collected and processed by the DCM 160 may then be consumed by an OSS/BSS (acting as a sink) for network monitoring and optimization. In another example, in another embodiment, a different OSS/BSS (acting as a source) may export subscriber-related data to the DCM 160 for use in generating consolidated reports. Network elements, such as DSLAMs, generally tend to be sources of data for the DCM 160 (i.e., data is communicated from the network elements to the DCM 160). In various embodiments, the OSSs or BSSs are capable of carrying out device or network monitoring and optimization, proactive troubleshooting, the offering of additional value-added services and even targeted or mass marketing through the CPE devices 110a, 110b, . . . , 110n or other channels such as television, radio, telephone or electronic or physical mail.

Having described elements of the CNO architecture of FIG. 1, various embodiments illustrating its operation will now be described. The management servers 150a, 150b, 150c of the management server cluster 150 communicate through the network 120 to manage the CPE devices 110a, 110b, . . . , 110n. Accordingly, the network carries management traffic from the management server cluster 150 to the CPE devices 110a, 110b, . . . , 110n. The CPE devices 110a, 110b, . . . , 110n that operate according to TR-069 generate their own management traffic, which is routed through the network 120 to the load balancer 130. As described above, the load balancer 130 distributes the management traffic from the CPE devices 110a, 110b, . . . , 110n among TRMs, including the TRM 140. In the illustrated embodiment, the load balancer 130 is configured to employ known distribution techniques (e.g., random, round-robin, zone-based, schedule-based or priority-based distribution techniques) to distribute management traffic representing new management sessions (e.g., containing session initiation messages) among the TRMs, including the TRM 140. “New management sessions” are defined as sessions initiated by the CPE devices 110a, 110b, . . . , 110n that have not already been assigned to a management server 150a, 150b, 150c for management.

The TRM 140 receives the management traffic representing the new management sessions the load balancer 130 distributed to it. In the illustrated embodiment, the TRM 140 is configured to employ known distribution techniques (e.g., random, round-robin, zone-based, schedule-based or priority-based distribution techniques) to distribute management traffic representing new management sessions among the management servers in the management server cluster 150, including the management servers 150a, 150b, 150c.

The TRM 140 also receives management traffic representing existing management sessions, defined as sessions initiated by a management server 150a, 150b, 150 and therefore already assigned to a management server 150a, 150b, 150c for management. In accordance with Nair, the TRM 140 is configured to examine payloads of packets to identify the management session to which the packets belong, if any. As Nair purports, management sessions may span multiple HyperText Transfer Protocol (HTTP) sessions. Thus, because the HTTP session does not reliably designate the management session, the TRM 140 looks past the HTTP session to identify the management session to which the packets belong. This may properly be regarded as a “deep” packet inspection.

The management traffic is thus routed to one of the management servers in the management server cluster 150, where a management server (e.g., the management server 150a, 150b, 150c) further handles the management traffic in a known manner. In the illustrated embodiment, the TRM 140 is further configured also to route at least some of the management traffic to the DCM 150 for storage, analysis and/or reporting.

As described above, the CNO architecture of FIG. 1 is further configured to handle supplemental traffic. The embodiment of FIG. 1 is configured to handle supplemental traffic according to both “push” and “pull” models.

According to the “push” model, the CPE devices 110a, 110b, . . . , 110n occasionally (e.g., periodically) generate supplemental traffic on their own initiative, and not in response to a contemporaneous request. In one embodiment, messages are transmitted to the CPE devices 110a, 110b, . . . , 110n that configuring CPE devices 110a, 110b, . . . , 110n to generate supplemental traffic, and therefore “push” supplemental information to the DCM 160, over time.

If a particular CPE device is a TR-069 device, its supplemental traffic is routed to the load balancer 130 and then to a TRM (e.g., the TRM 140). The TRM 140 is configured to identify the supplemental traffic as such and forward it to the DCM 160 for storage, analysis and/or reporting. If a particular CPE device is capable of directing the supplemental traffic it generates (for example if it supports the TR-232 standard), then it can send this traffic directly to the DCM, perhaps by way of a load balancer (e.g., the load balancer 130, as shown). As those skilled in the art are aware, requests for CPE device parameters may not be sufficiently specific to request only desired parameters. Thus, some parameters may be contained in supplemental traffic that are not needed for storage, analysis or reporting. Therefore, in one embodiment, the TRM 140 filters out parameters that are not of interest before forwarding the supplemental traffic to the DCM 160.

According to the “pull” model, the CPE devices 110a, 110b, . . . , 110n generate supplemental traffic in response to a contemporaneous request. In the illustrated embodiment, the contemporaneous request is received from one of the management servers 150a, 150b, 150c. In a manner to be illustrated in greater detail below, the supplemental request may be generated in response to a high-level request originating in an external system, such as one or more OSSs or BSSs 170 and transformed into one or more low-level requests by the DCM 160. In an alternative embodiment, the supplemental request may be a scheduled event, e.g., a scheduled job that requires supplemental traffic, for example a log file, to be generated every 24 hours. Irrespective of the manner in which the contemporaneous request may be generated, one or more of the CPE devices 110a, 110b, . . . , 110n generate supplemental traffic in response. As above, if a particular CPE device is a TR-069 device, its supplemental traffic is routed to the load balancer 130 and then to a TRM (e.g., the TRM 140). The TRM 140 is configured to identify the supplemental traffic as such and forward it to the DCM 160 for storage, analysis and/or reporting. If a particular CPE device supports a protocol based on IPDR, the CPE device is capable of directing the supplemental traffic it generates to the DCM, perhaps by way of a load balancer (e.g., the load balancer 130, as shown).

Those skilled in the pertinent art understand that TR-069 devices can support the “pull” model, perhaps in response to the way they are configured. In one embodiment, the TRM 140 is capable of configuring TR-069 devices remotely to effect the “pull” model.

In some embodiments, the TRM 140 collects supplemental information based on configurable rules. For example, rules may exist to identify CPE devices in a “watchgroup” that is being monitored on a frequent basis. In one embodiment, the TRM 140 is configured to collect data only from CPE devices identified as being in this watchgroup, and no others. Other embodiments support multiple watchgroups.

In some embodiments, the TRM 140 can issue additional management requests to the CPE devices explicitly to retrieve supplemental data on behalf of the DCM 160. For example, configuration directives may be specified to the TRM 140 indicating a set of parameters to be retrieved from the CPE device, whether or not these parameters were present in the initial message from the CPE device. When operating in the “pull” model, the TRM 140 injects additional commands, e.g., via a management channel, to one or more CPE devices to retrieve desired parameters and send them to the DCM 160.

In one embodiment, the CPE devices 110a, 110b, . . . , 110n communicate with the TRM 140 over the network 120 using Secure HTTP (HTTP/S). In another, perhaps related embodiment, the TRM 140 and the management servers 150a, 150b, 150c are resident on a single physical server. In a related embodiment, the TRM 140 takes the form of a physical processor executing instructions stored as software in a non-transitory medium. In one specific embodiment, the instructions execute under the Solaris® operating system on hardware using either the commercially available Sun® SPARC® or Intel® x86® processors. In a related specific embodiment, the instructions are implemented using the well-known C programming language, executing in the context of a standard HTTP server.

In other embodiments, the TRM 140 takes the form of as a combination of executable software and hardware such as an application-specific integrated circuit (ASIC). The TRM 140 may be a standalone device or incorporated in a multifunction apparatus that performs other duties as well. In some implementations, the TRM 140 may be implemented in the HDM physical server, perhaps together with one or more managed servers executing on the same HDM physical server.

FIG. 2 is a block diagram of one embodiment of the TRM 140 of FIG. 1. The TRM 140 includes a payload analyzer 210. In the illustrated embodiment, the payload analyzer 210 is configured to receive management and supplemental information from CPE devices (e.g., the CPE devices 110a, 110b, . . . , 110n) and further configured to examine the payloads of the packets bearing the management and supplemental information to identify the management session, if any, to which the packets belong. If the payload analyzer 210 identifies a packet as bearing supplemental information, the payload analyzer 210 is configured to forward the packet to the DCM (160 of FIG. 1).

The TRM 140 also includes a traffic prioritizer 220. In the illustrated embodiment, the traffic prioritizer 220 is configured to receive packets bearing management information from the payload analyzer 210 and prioritize them according to one or more criteria. The criteria may include a management issue severity, a session length or a CPE device service level.

The TRM also includes a traffic allocator 230. In the illustrated embodiment, the traffic allocator 230 is configured to employ known distribution techniques (e.g., random, round-robin, zone-based, schedule-based or priority-based distribution techniques) to distribute management traffic representing new management sessions among management servers (e.g., the management servers 150a, 150b, 150c of FIG. 1). Otherwise, the packet belongs to an existing management session, in which case the traffic allocator 230 is configured to send the packet to the management server that is already handling the management session.

The TRM 140 further includes a low-level request generator 240. In the illustrated embodiment, the low-level request generator 240 is configured to translate a high-level request for supplemental information (e.g., a request by a DCM for the times of day during which each CPE device is in use) into one or more low-level requests for supplemental information (e.g., a high-level request to fetch data corresponding to a Quality of Service, or QoS, for Internet access is mapped to a set of low-level requests (GPVs) to an object model of a TR-069 router device). In the illustrated embodiment, the low-level request generator 240 is further configured to send the low-level requests to the traffic prioritizer 220, which is, in turn, configured to prioritize them, along with packets bearing management information received from the payload analyzer 210, according to the one or more criteria.

FIG. 3 is a flow diagram of one embodiment of a method of regulating basic management and supplemental traffic. The method begins in a start step 310. In a step 320, management traffic and supplemental traffic are received from a network. In a step 330, a packet payload is analyzed to determine the type of traffic it represents: management traffic or supplemental traffic. In a step 340, if the packet represents supplemental traffic, it is forwarded to a DCM. If the packet represents management traffic, a priority is assigned to it. In a step 350, management traffic is allocated among management servers. In a step 360, a high-level request for supplemental information is received, and at least one low-level request is generated in response thereto. In a step 370, the resulting low-level supplemental information request is allocated to management servers for fulfillment. The method ends in an end step 380.

FIG. 4 is a block diagram of one embodiment of the DCM 160 of FIG. 1. The DCM 160 includes an information analyzer 410. In the illustrated embodiment, the information analyzer 410 is configured to analyze at least supplemental information to allow some understanding or benefit to be gained from it. In some embodiments, the information analyzer 410 is further configured to analyze management information in addition to supplemental information. In the illustrated embodiment, the information analyzer 410 is configured to interact with a database 420 containing at least supplemental information and perhaps management information as well.

In the illustrated embodiment, external systems, such as one or more OSSs or BSSs (e.g., the one or more OSSs/BSSs 170 of FIG. 1), interact with the information analyzer 410 to cause it to analyze supplemental information, management information, or both. For example, the information analyzer 410 may include a database management system (DBMS) configured to execute one or more programs to analyze supplemental and/or management information.

The DCM 160 further includes a management and supplemental traffic receiver 430. In one embodiment, the management and supplemental traffic receiver 430 is configured to receive supplemental traffic from one or more CPE devices (e.g., the CPE devices 110a, 110b, . . . , 110n of FIG. 1) and one or more TRMs (e.g., the TRM 140 of FIG. 1) and cause the supplemental information to be stored in the database 420. In another embodiment, the management and supplemental traffic receiver 430 is further configured also to receive management traffic from one or more TRMs and cause the management information also to be stored in the database 420.

The DCM 160 still further includes a high-level request generator 440. In one embodiment, the high-level request generator 440 is configured to generate a high-level request (e.g., a request for the times of day during which each CPE device is in use) based on a prompt (e.g., a request originating from a management server user, an OSS or a BSS, for a report on overall CPE device utilization).

It is apparent from the above that the DCM 160 and TRM 140 of FIGS. 1 and 2 cooperate to allow a management server user, OSS or BSS originate a request for information at a very high, abstract level, at which point the DCM 160 and TRM 140 translate or transform the request in stages into low-level requests that are appropriate for requesting information from specific CPE devices. This overall CNO architecture allows the management server user, OSS or BSS to ignore implementation details involved in fulfilling the request; the DCM 160 and TRM 140 are able to handle the details. In an alternative embodiment, systems other than the DCM 160 and TRM 140 (not shown) assist in the translation or transformation of very high, abstract requests. In another alternative embodiment, either the DCM 160 or the TRM 140 perform the entire translation or transformation function.

FIG. 5 is a flow diagram of one embodiment of a method of requesting and collecting supplemental data. The method begins in a start step 510. In a step 520, a request for supplemental information is received from an external system, such as an OSS or BSS. In a step 530, a high-level information request is generated and transmitted to a TRM. In a step 540, supplemental traffic is directly received from CPE devices. In a step 550, forwarded supplemental traffic is received from a TRM. In a step 560, interactions occur with a database during which the supplemental information is stored and retrieved. In a step 570, a report is produced based on the supplemental information. The method ends in an end step 580.

It is important to note that the method of FIG. 5 should not be taken to imply a “synchronous” flow in which a high-level request from an OSS/BSS necessarily initiates data collection. In fact, in various applications particularly involving TR-069 devices, the “push” model may be in use, under which the devices are continually generating supplemental traffic. Further, the OSS/BSS may modify what is being collected and the devices from which it is collected. However, the collection does not need to rely (or be gated by) the OSS/BSS for a decision on each event from every device.

Those skilled in the art to which this application relates will appreciate that other and further additions, deletions, substitutions and modifications may be made to the described embodiments.

What is claimed is:

1. A traffic regulation manager, comprising:
a payload analyzer configured to receive management and supplemental information from customer premises equipment devices, examine payloads of packets bearing said management and supplemental information to identify the management session and, if a packet is bearing said supplemental information, forward said packet to a data collection manager;
a traffic prioritizer coupled to said payload analyzer and configured to receive said packets bearing said management information from said payload analyzer and prioritize said packets according to at least one criterion; and
a traffic allocator coupled to said traffic prioritizer and configured to distribute management traffic representing new management sessions among management servers and packets representing existing management sessions to a management server already handling said existing management sessions.

2. The manager as recited in claim 1 wherein said criteria include:
a management issue severity,
a session length, and
a customer premises equipment device service level.

3. The manager as recited in claim 1 wherein said traffic allocator is configured to employ random, round-robin, zone-based, schedule-based or priority-based distribution techniques to distribute said management traffic representing said new management sessions.

4. The manager as recited in claim 1 further comprising a low-level request generator coupled to said traffic prioritizer and configured to translate a high-level request for supplemental information into at least one low-level request for supplemental information.

5. The manager as recited in claim 4 wherein said traffic prioritizer is further configured to receive packets bearing said low-level requests for information from said low-level request generator and prioritize said packets according to said at least one criterion.

6. The manager as recited in claim 1 wherein said customer premises equipment devices are TR-069 devices.

7. The manager as recited in claim 1 wherein said manager is embodied as a physical processor executing instructions stored as software in a non-transitory medium.

8. A method of regulating basic management and supplemental traffic, comprising:
receiving management and supplemental traffic from a network;
analyzing a packet payload to determine a type of traffic said packet represents;
if said packet represents supplemental traffic, forwarding said packet to a data collection manager;
if a packet represents management traffic, assigning a priority to said packet; and
allocating said management traffic among management servers.

9. The method as recited in claim 8 wherein said assigning is carried out according to at least one criterion selected from the group consisting of:
a management issue severity,
a session length, and
a customer premises equipment device service level.

10. The method as recited in claim 8 wherein said allocating comprises employing random, round-robin, zone-based, schedule-based or priority-based distribution techniques to distribute management traffic representing new management sessions.

11. The method as recited in claim 8 wherein said allocating comprises allocating packets representing existing management sessions to a management server already handling said existing management sessions.

12. The method as recited in claim 8 further comprising:
receiving a high-level request for supplemental information; and
generating at least one low-level request in response thereto.

13. The method as recited in claim 12 further comprising allocating said at least one low-level request to said management servers.

14. The method as recited in claim 8 wherein said receiving comprises receiving said management traffic and said supplemental traffic from TR-069 devices coupled to said network.

15. A communication network operator architecture, comprising:
a plurality of management servers;
a data collection manager; and
a traffic regulation manager coupled to said plurality of management servers and said data collection manager and including:
a payload analyzer configured to receive management and supplemental information from customer premises equipment devices, examine payloads of packets bearing said management and supplemental information to identify the management session and, if a packet is bearing said supplemental information, forward said packet to a data collection manager,
a traffic prioritizer coupled to said payload analyzer and configured to receive said packets bearing said management information from said payload analyzer and prioritize said packets according to at least one criterion, and
a traffic allocator coupled to said traffic prioritizer and configured to distribute management traffic representing new management sessions among said plurality of management servers and packets representing existing management sessions to a management server already handling said existing management sessions, said data collection manager configured to collect, store and report at least said supplemental information.

16. The architecture as recited in claim 15 wherein said data collection manager comprises an information analyzer configured to analyze at least supplemental information.

17. The architecture as recited in claim 15 wherein said data collection manager is further configured to analyze management information in addition to said supplemental information.

18. The architecture as recited in claim 15 wherein said data collection manager comprises:
a database configured to contain at least said supplemental information; and
an information analyzer configured to interact with said database.

19. The architecture as recited in claim 15 wherein said data collection manager is configured to interact with external systems, including at least one operations support system or business support system.

20. The architecture as recited in claim 15 wherein said data collection manager comprises a management and supplemental traffic receiver configured to receive supplemental traffic from said customer premises equipment devices and said traffic regulation manager.

21. The architecture as recited in claim 15 wherein said data collection manager comprises a high-level request generator configured to generate a high-level request based on a prompt.
